(19) United States
(12) Patent Application Publication
(10) Pub. No.: US 2009/0062941 A1
(43) Pub. Date: Mar. 5, 2009

(54) HEAT INDEX

(75) Inventors: Bryan Biniak, Los Angeles, CA (US); Richard Berroteran, Reseda, CA (US); Chris Cunningham, Los Angeles, CA (US); Atanas Ivanov, Santa Monica, CA (US); Jeffrey Marks, Sherman Oaks, CA (US); Brock Meltzer, Los Angeles, CA (US)

Correspondence Address: DLA PIPER US LLP, 1999 AVENUE OF THE STARS, SUITE 400, LOS ANGELES, CA, 90067-6023, US

(73) Assignee: JACKED, INC., Santa Monica, CA (US)

(21) Appl. No.: 12/201,971

(22) Filed: Aug. 29, 2008

Related U.S. Application Data
(60) Provisional application No. 60/968,840, filed on Aug. 29, 2007.

(51) Int. Cl. G06F 19/00

(52) U.S. Cl. 700/91

(57) ABSTRACT

The system generates a heat index for each player in a sporting event. Historical data is maintained over time and is available for display by a user. In one embodiment, the heat index is provided via a network such as the internet. In another embodiment, the heat index is displayed as part of an event or game broadcast. The heat index represents the current level of performance of a player pursuant to a calculation algorithm that includes objective and subjective information. The objective information includes statistical data from a game or contest. The subjective information may include references from announcers and input from viewers.

This patent application claims priority to U.S. Provisional Patent Application 60/968,840 filed Aug. 29, 2007 and entitled “Heat Index”, which is incorporated herein by reference in its entirety.

### BACKGROUND OF THE SYSTEM

When viewing sporting events, a large amount of statistical, performance, and background information is provided by the announcers and embedded within the broadcast itself. One type of information that is often provided is how “hot” or “cold” a player might be during the contest. For example, in basketball, if a player has made a few shots in a row, that player is typically considered to be hot. When a player is only making a low percentage of shots, that player is considered to be cold. A problem with such characterizations is that they are often based solely on subjective criteria, i.e. that of the announcer, or from a limited set of statistical data, i.e. the few most recent shots or period of activity of the player.

In some cases, more long term characterizations of hot and cold are presented to consumers. Often a periodical or web site will present a feature called “Who's Hot and Who's Cold” which will be based on a very short time period, often one or two weeks of play. Other such presentation may be season long but are limited in scope. For example, the NFL calculates a quarterback rating for each season and publishes the data week by week. In addition, the quarterback rating may be calculated during a game for the game to that point or even on a quarter by quarter or drive by drive basis.

The disadvantages with present systems for presenting performance characterizations are the lack of real time calculation and presentation, the limit to one or two positions, the focus on team statistics or aggregation instead of individual player performance, the reliance on either subjective or objective statistics solely, and the focus on current status instead of trends.

### BRIEF SUMMARY OF THE SYSTEM

The system generates a performance index (herein called a heat index) for one or more players in a sporting event. Historical data is maintained over time and is available for display by a user. In one embodiment, the heat index is provided via a network such as the internet. In another embodiment, the heat index is displayed as part of an event or game broadcast. The heat index represents the current level of performance of a player pursuant to a calculation algorithm that includes objective and subjective information. The objective information includes statistical data from a game or contest. The subjective information may include references from announcers and input from viewers.

### BRIEF DESCRIPTION OF THE DRAWINGS

FIG. 1 is a flow diagram illustrating an embodiment of the presentation of the heat index.

FIG. 2 is an alternate embodiment of the presentation of heat index.

FIG. 3 is a table illustrating the generation of a heat index in basketball.

FIG. 4 is a flow diagram illustrating coefficient updating.

FIG. 5 is a flow diagram illustrating event based heat index updating.

FIG. 6 is a flow diagram illustrating in-game decay.

FIG. 7 is a flow diagram illustrating subjective factor heat index updating.

FIG. 8 is a flow diagram illustrating a linking scheme.

FIG. 9 is a flow diagram illustrating an alert scheme.

FIG. 10 is a block diagram of an example computer system for use with the present system.

### DETAILED DESCRIPTION OF THE SYSTEM

The present system provides a player by player heat index that automatically includes input from both subjective and objective information and data. The heat index is presented graphically so that a consumer can view at a glance how the player is trending over time and/or with respect to certain game situations. The system includes both historical presentation as well as game by game presentation so that the consumer can use the information to make predictions and to assess current performance and expectations. The system uses algorithms that can be applied, for example, to every player on a basketball team, to indicate effectiveness even in the absence of traditional indicators such as scoring. By tracking the mention and context of player name mentions, the system can track the heat of a player who may be accomplishing effective play even in the absence of traditional statistical and objective markers. Often times an announcer will mention that a player is “doing things that don't always show up in the box score” and the present system can automatically represent such value.

In one embodiment, all players begin a game at a certain default base level representing the heat index of the player. When a player is playing and accumulating statistics and announcer mentions, the heat index will increase. When a player is on the bench, the heat index decreases over time because the player is not performing. In addition, when a player is in the game but not performing well or not accumulating statistics or mentions, the player's heat index will decrease (typically more quickly than for a player not playing at all). The heat index of one or more players may be displayed graphically as a line graph over game time. The heat index may be normalized to a presentation range or it may be open ended depending on the actual performance of the player. In addition to current game performance, historical information about the player is archived and may be optionally presented to the consumer. In one embodiment this historical data is also presented as a line graph of heat index value over game time. In this manner, a consumer might be able to spot trends where a particular player performs at a high or low level.

The data may also be separated by opposing team, by game situations (team ahead, team behind, in wins, in losses), or by opposing player as desired. The data may be color coded so that a hot player might be represented by, for example, a red line and a cold player by a blue line. The system may also be tied to an alert mechanism so that when a favorite player is performing above or below a certain threshold, an alert is automatically forwarded to an interested user. This alert may be via email, IM, cell phone, or some other notification means.

Presentation

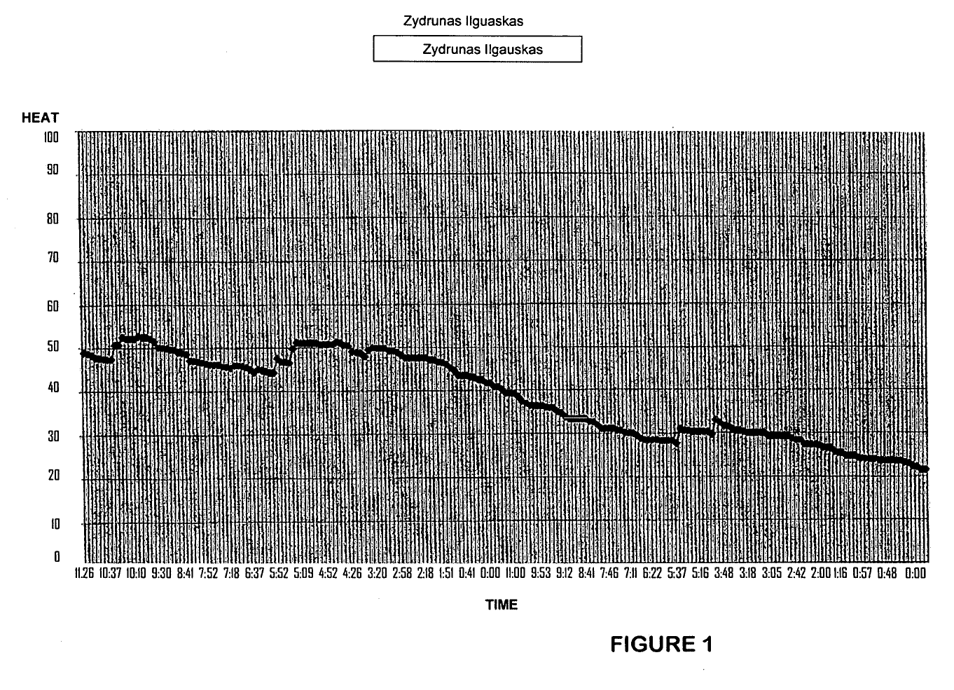

FIG. 1 is a diagram illustrating the presentation of the heat index for a player during a game. The heat index is given by way of example only. The heat index may be presented in other formats without departing from the scope or spirit of the system. In the example of FIG. 1, the heat index is shown for a basketball player (e.g. Zydrunas Ilgauskas). The heat index is presented as a line graph on an x-y axis with the y axis being the value of the heat index and the x axis being time of game.

In one embodiment of the system, the heat index for all players is set at a value of 50 at the beginning of a game. If the player is not playing, the heat index slowly decreases over time. As noted in the graph of FIG. 1, the player was not playing at the beginning of the game, first appearing at the 10:37 mark of the first period. As can be seen, the heat index for the player nevertheless decreased while the player was on the bench. When the player is actually playing, some statistical efforts may impact the numerical value of the heat index. Initially, this player made his first attempted shot and sent his heat index above 50 during the early part of the game. Unfortunately for this player, his performance was not positive in this game and his heat index had a steady decline to a value near 30 by the end of the game. As noted previously, the heat index can decline by inaction (being benched) as well as playing without acquiring positive statistics. Unwanted statistics, (personal fouls, turnovers, etc.) can also lead to a negative heat index.

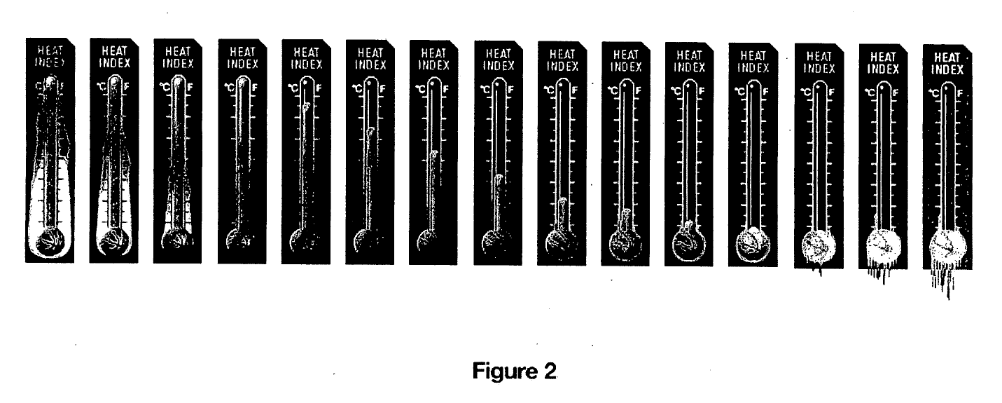

FIG. 2 is graphical representation of an alternate embodiment of displaying a heat index. In this case a range of heat is shown from a value of zero (ice cold snow covered thermometer on the far right) to a value of 100 (thermometer glowing red hot on the far left). The current heat of a player is indicated by the position of mercury in the thermometer. In one embodiment, a player can never have a negative value. This means that if they have played very badly and are at 0, one good play should register as the mercury increasing. A player can have a value above 100.

Calculation

As note above, in one embodiment all players start the game with a value of 50 and their actions (or lack of actions) affect their heat index value at every play by play instance by generating a change value that is applied to the current heat index to generate a new heat index (which then becomes the current heat index). The change values are associated with events, time, and have values that are different depending on the event. There are a number of conditions under which a players heat index can be affected. In one case, the player is involved in the game and generating statistics. This generates a value which varies positively or negatively by action as outlined further below. In another case, the player is in the game, but not involved in the play. This generates a slow decay of their heat index based on time elapsed. Finally, the player may be on the bench (not in the game). This generates a medium decay of their heat index based solely on time elapsed.

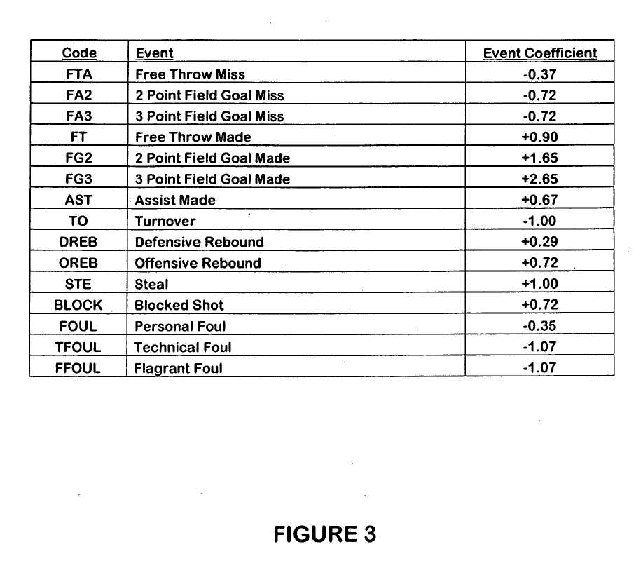

If a player is involved in the play by play, the heat index is affected principally by objective statistics. FIG. 3 is a table illustrating the statistics and their impact on the heat index in one embodiment of the system applied to basketball.

As you might expect, positive events include scoring, shots on goal, assists, rebounds, interceptions, steals, and blocking shots. Negative events include missed baskets (field goals and free throws), turnovers, fumbles, and fouls/penalties.

Normalization

In one embodiment of the system, the event coefficients are determined so that an “average” player will have a heat index of 50. Statistics from prior or even current seasons can be used to determine what the coefficients should be so that the median heat score for players is 50.

Although the coefficients can be equally applied to all players in one embodiment, it is also possible to have specific coefficients and events based on position. For example, a center or forward is more likely to have rebounds than a guard in basketball. A guard who has, for example, ten rebounds should be considered hotter than a center who has ten rebounds. Similarly, a center with a high number of assists should be hotter than a guard with a similar number of assists.

In some sports, such as football, many of the positions do not generate very many objective statistics. For example, the statistics for an offensive lineman are often negative statistics, (e.g. penalties incurred, sacks allowed, etc.). The system contemplates heat indexes for entire units or sub-units of players in addition to a heat index for an individual player. In football, there may be heat indexes for the defense as a whole, for defensive linemen as a sub-group, for linebackers and secondaries as well.

Updating of Coefficients

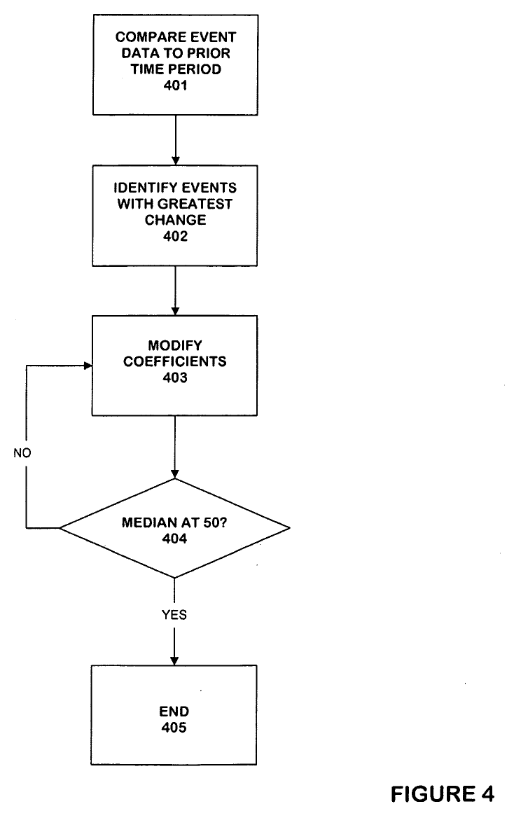

To update coefficients, the system contemplates a number of techniques. From season to season, the statistics of an “average” player may change, requiring change in one or more coefficients. The system contemplates updating coefficients so that an average performer will have a heat index of approximately 50. In one technique, illustrated in FIG. 4, the system determines if the prior season's data still results in an average player scoring a heat index of approximately 50. If not, the system will update coefficients as necessary. At step 401, the system examines the data for each event and compares it to prior seasons. At step 402 the system determines which event statistics show the greatest variation from the prior season. At step 403, the system begins modifying coefficients, starting with the coefficients of the events with the most variation identified in step 402. At decision block 404 the system checks to see if the new coefficients result in a heat index score of 50 for an average player. If not, the system returns to step 403. If so, the system ends at step 405. Although one embodiment uses a season by season approach to coefficient generation, the system also contemplates other suitable time periods for sampling, even within a season.

Player Involved:

In one embodiment of the system, a player's heat index is made up of the sum of an event algorithm, an in-game decay algorithm, and a bench decay algorithm. At any one time, only two of the algorithms are active because a player is either in the game (so that event and in-game decay would apply) or out of the game (so that bench decay would apply). The following event algorithm is used to generate a new heat index from a previous heat index and an event for an active player.

new heat index=previous heat index+(4×event coefficient).

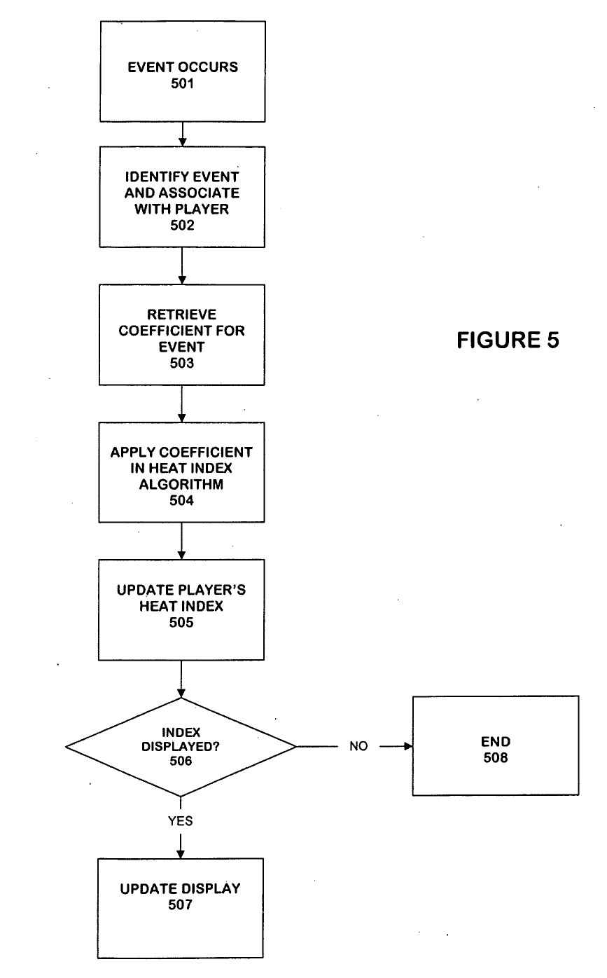

FIG. 5 is a flow diagram illustrating the operation of the event heat algorithm. At step 501 an event occurs in the game. At step 502 the event is identified and associated with a player. This identification and association may be done by reviewing a statistical feed that is provided for the event. In an alternate embodiment, this information could be via review of closed captioning, optical recognition, speech-to-text conversion, or any other suitable method. At step 503 the coefficient for that event is retrieved from a look-up table. (In one embodiment, the system retrieves the coefficient from a table associated with the position of the player). At step 504 the coefficient is used in the event algorithm (e.g. new heat index=previous heat index+(4×event coefficient).

At step 505 the player's associated heat index is updated pursuant to the results of step 504. At decision block 506 it is determined if the player's heat index is currently being displayed (in some embodiments, a user may select one or more heat indexes of interest). If so, the system updates the player's displayed heat index at step 507. If not, the system ends at step 508.

It should be understood that other algorithms may be used with the system as well without departing from the scope or spirit of the system.

Example of Event Impact in Football

The following are examples of events that can affect heat index in a football game: Throw attempts, Throw completions, Throw percent completion, Passing yards, Average passing yards per attempt, Passing touch down, Interception, Sack, Sack yards lost, Penalty, Penalty yards lost, Fumble lost, Running touch down, Running attempt, Running yards, Running average yards per attempt, 1st down achieved on 1^{st} or 2^{nd} down, 1st down achieved on 3^{rd} down, 1st down achieved on 4^{th} down, Reception for touch down, Reception completion, Receiving yards, Average yards per receipt, Solo Tackle, Assisted Tackle Touchback, Kick inside the 20, Punt attempt, Punt Yards, Average yards per punt attempt, Field goals made, Field goals attempted, Field Goal distance, Extra point made, Extra point attempted, Team running attempts, Team running yards, Team average yards per attempt, Team running touch downs, Offensive play decay, Block kick, Pass block, Pass intercepted, Force fumble, Fumble recovered, Team points allowed, Team yards against, Defensive play decay.

Example for a Specific Running Back with Current Heat Index of 78:

Play starts, QB hands off to RB, RB gains 11 yards and fumbles

11 yard run (RB running coefficient is 0.5/yrd)=+5.5

This run give this player an average yrds/carry of 6 (coefficient at 6 is +1)=+1

1 Fumble (fumble lost coefficient is −20)=−20

All players on offense get decay (offensive decay coefficient is −0.25)=−0.25

Total Play value is =−13.75

Play value divided by play coefficient of 1.5 give a heat value of −9 for this player for this play

Running back now has a heat index of 69

Example for a Specific Defensive Back with Current Heat Index of 55:

Play starts, Defensive unit gives up 11 yards and recovers a fumble

Defensive unit gives up 11 yards (coefficient is −0.025)=0.275 (applied to all defensive players)

1 fumble is recovered (fumble recovered coefficient is 20)=+20

All players on defense get decay (defense decay coefficient is −0.25)=−25

Total Play value is +19.48

Play value divided by play coefficient of 1.5 give a heat value of +13 for this player for this play

Defensive Back now has a heat index of 68

In-Game Decay:

If a player is in the game, but NOT involved in the current play by play, then the following algorithm is used to generate a new heat index.

new heat index=previous heat index−1.5×min elapsed

For example if 20 seconds elapsed since the last play by play, all players who are in the game but not involved in the current play will lose 0.5 off of their current heat index.

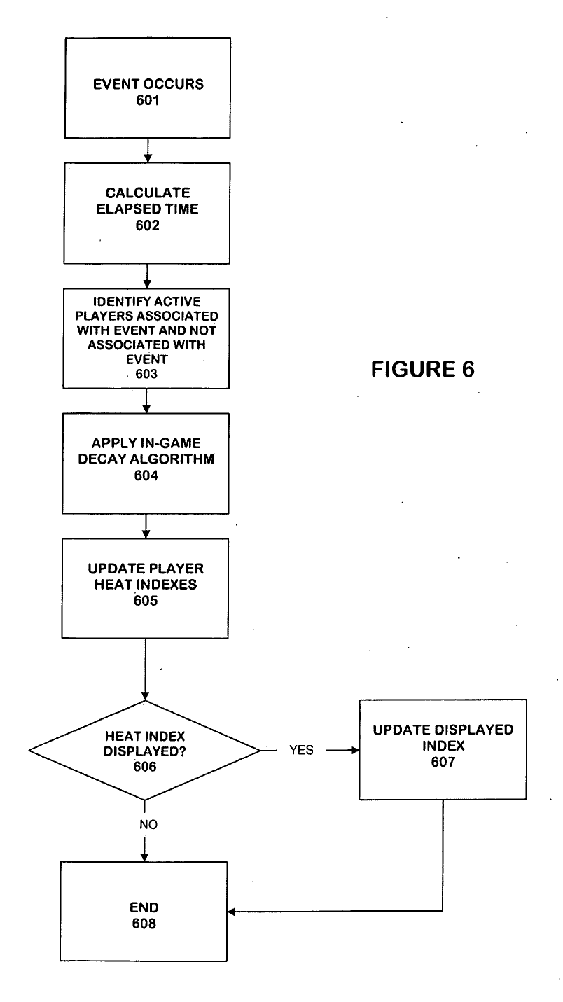

This adjustment to the heat index can be implemented as illustrated in FIG. 6. At step 601 an event occurs. At step 602 the system determines the elapsed time (e.g. game time) since the previous event. At step 603 the system identifies all active players associated with the event. At step 604 the system applies the in-game delay algorithm (e.g. new heat index=previous heat index−1.5×min elapsed) to all players not associated with the event using the elapsed time. At step 605 the system updates the heat indexes for each of those players not associated with the event. At decision block 606 the system determines if any of the players whose heat indexes were updated have an associated heat index display. If so, the displayed heat indexes of those players are updated at step 607. If not, the system ends at step 608.

In another embodiment, the system applies an in-game decay algorithm to all in-game players based on a fixed elapsed time period, regardless of whether an event has occurred or whether a player is associated with an event. For example, every 20 seconds of game time results in an in-game decay update to each active player's heat index. In other embodiments, a separate clock is kept for each player and is updated periodically based on how long each individual player is in the game.

On-Bench Decay:

If a player is out of the game, the following algorithm is used to generate a new heat index.

new heat index=previous heat index−2.25×min elapsed

For example if 20 seconds elapsed since the last play by play, all players NOT in the game will lose 0.75 off of their heat index.

NOTE: Every player has their heat index re-calculated for every play-by-play received. Most players will get generic adjustments unless they have been involved in the play-by-play. For the purposes of triggering heat index changes, involved in the play-by-play can mean that the player's stats have changed.

Subjective Factors

In addition to the objective factors of time and statistics, the system contemplates the use of subjective factors to impact the heat index of a player. For example, the announcing and play-by-play feeds can be data mined to detect mention of a players name. The mention of a name may generate a positive change in the heat index. In another embodiment, attempts are made to determine the context of the mention of a player's name. For example, a negative comment about a player will cause the heat index of that player to fall. A positive comment about a player will cause the heat index of that player to rise. There are a number of times where a player may be playing very well even if that player is not generating statistics. For example, by playing good defence on an opposing player, drawing charging or other fouls, setting good screens for team-mates, or other events that might be noticed by an announcer but not be reflected in the statistics of that player. The use of subjective factors will result in the heat index of that player being increased. In one embodiment, an algorithm is used to determine how many positive or negative points to apply to a player's heat index based on positive or negative mentions.

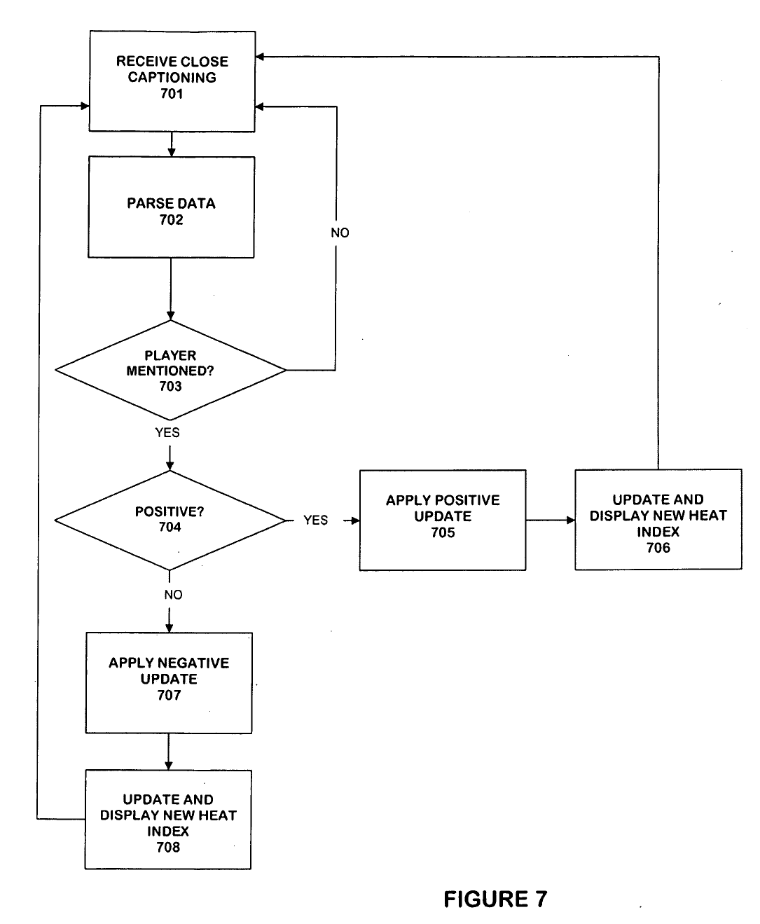

FIG. 7 is a flow diagram illustrating the operation of subjective factor updating of heat index. At step 701 the system receives new closed captioning data. At step 702 the system parses the data. At decision block 703 it is determined if any players in the game are mentioned. If not the system returns to step 701.

If so, the system determines at decision block 704 if the mention is positive. This may be accomplished by comparing the words around the mention of the player to a database of words and phrases that have been identified as positive. In other cases a human operator can determine if the mention is positive. If the mention is positive at step 704, the system applies a positive subjective factor heat index update algorithm to the player's heat index at step 705. At step 706 the player's heat index is updated and displayed if appropriate. In one embodiment, the system is such that positive mentions of the player will negate the effect of in-game decay. In other embodiments, other values can be implemented.

If the mention is not positive at step 704, it is assumed to be negative and a negative subjective factor heat index update algorithm is applied at step 707. At step 708 the player's heat index is updated and displayed if appropriate. After steps 706 or 708, the system returns to step 701. In one embodiment of the system, negative mentions can double the effect of in-game decay. In other embodiments, other negative values of impact on the heat index may be used.

Linking and Alerts

In one embodiment of the system, the graphical representation of the heat index also acts as a link to data and/or media content related to the player. In one embodiment, the type of content that is returned is dependent on the value of the heat index at the time. For example, if the player currently has a low index, the content returned could be examples of poor play by the player in the present game or in past games. Conversely, when the player has a high heat index, the content could be of highlight plays from the present game or the past.

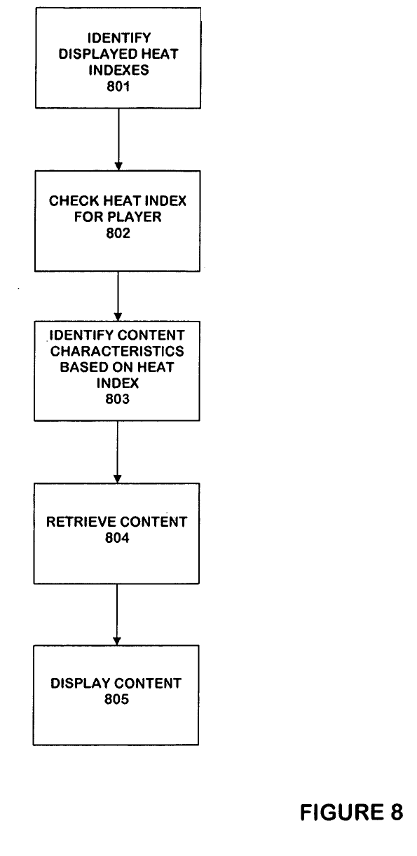

FIG. 8 is a flow diagram illustrating a heat index linking scheme in one embodiment of the system. At step 801 the system identifies those players whose heat index is currently being displayed. At step 802 the system checks the value of the heat index of a displayed player. At step 803 the system identifies content characteristics associated with the current heat index for the player. (As noted above, a high or low score is associated with certain type of data associated with a player). At step 804 the system retrieves content having the associated characteristics. This could be accomplished by implementing a content retrieval system such as is described in pending U.S. patent application Ser. No. 11/849,239 filed Aug. 31, 2007, entitled “Method and Apparatus for Providing Secondary Content Based on Primary Broadcast” and assigned to the assignee of the present application, incorporated herein in its entirety by reference. At step 805 the system displays the retrieved content.

The system can also provide a scheme for alerting a user when the player's heat index is at a certain level. A user may want to be alerted if a favorite player has a high heat index so that the user can turn on the game or perform some other appropriate action. In some cases, fantasy sports team owners may want to know if one of their players is performing particularly well or particularly poorly.

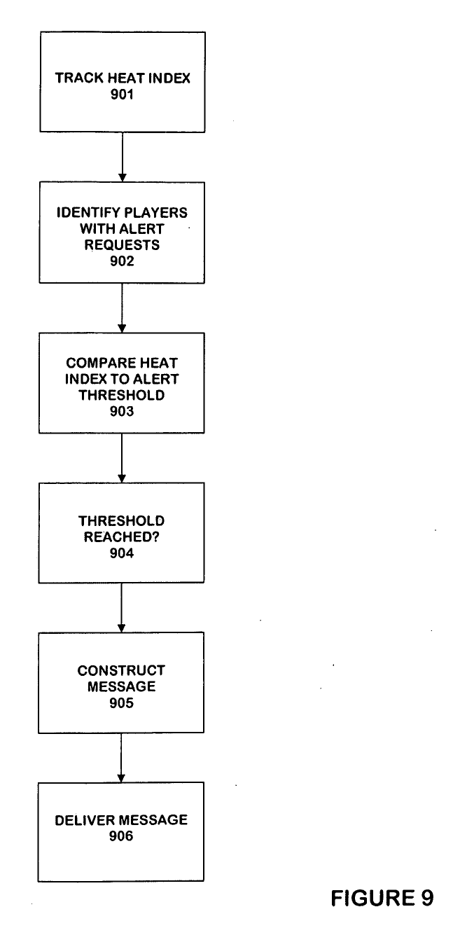

FIG. 9 is a flow diagram illustrating an alert scheme in one embodiment of the system. At step 901 the system tracks the heat index of each player in the game. At step 902 the system identifies any of the players in a game that has an alert request associated with the heat index. At step 903 the system compares the heat index of the player to the alert value. This alert value may be a setting selected by a user who wants an alert whenever the player's heat index is above a certain value. This will enable the user to seek out the game to see the player. The alert value may also be such that the user wants to be alerted if the heat index is below a certain value. At step 904 the system determines if an alert value has been reached. If so, the system constructs a message at step 905. At step 906 the system sends the message using a method selected by the user. In one embodiment, any number of users my have alerts associated with a player, all with different alert values to trigger the sending of an alert message.

Dynamic Heat Index Generation

In one embodiment the heat index calculation coefficient is dynamically adjusted during a game on a player by player basis based on certain performance parameters of the player. For example, in football, a quarterbacks heat index coefficient may be increased as the completion percentage of the quarterback increases. This provides a non-linear growth in heat index for a player who is playing at a high level.

Display Options

In one embodiment, the system allows the user to custom tune a heat index in real time or in a historical context. This allows the user to graphically see statistical correlations for a player. For example, the user may be able to compare a player's heat index history over the course of a game with one or more previous games, one or more previous seasons, or over a career. The user can also compare heat index values for a player based on the presence in the game of one or more team-mates or even opponents.

Voting Panel

In one embodiment of the system, a voting box appears next to the displayed heat index of a player. After an event, users are able to vote as to whether the heat of the player is fairly increased or decreased. For example, if a negative event occurs but seems to be due to poor officiating, fans of the player may choose to vote that the heat index of the player should not be adjusted too negatively. Similarly, if some circumstance seems to give an unfair advantage to a player, the user may vote to diminish the increase in heat index.

Example Computer System

Embodiment of Computer Execution Environment (Hardware)

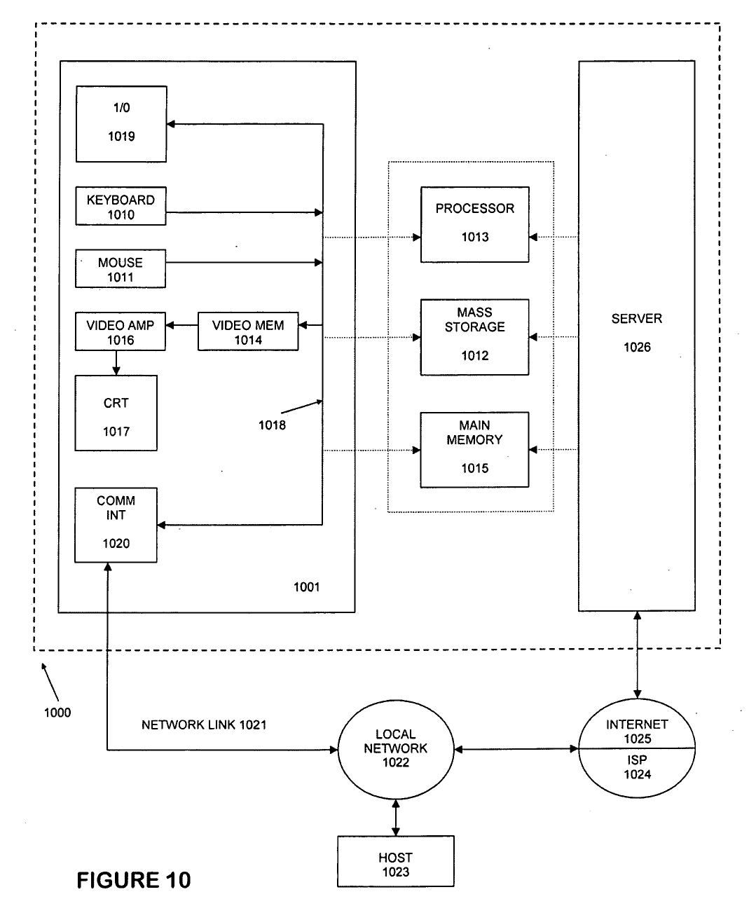

An embodiment of the system can be implemented as computer software in the form of computer readable program code executed in a general purpose computing environment such as environment 1000 illustrated in FIG. 10, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 1010 and mouse 1011 are coupled to a system bus 1018. The keyboard and mouse are for introducing user input to the computer system and communicating that user input to central processing unit (CPU 1013. Other suitable input devices may be used in addition to, or in place of, the mouse 1011 and keyboard 1010. I/O (input/output) unit 1019 coupled to bi-directional system bus 1018 represents such I/O elements as a printer, A/V (audio/video) I/O, etc.

Computer 1001 may include a communication interface 1020 coupled to bus 1018. Communication interface 1020 provides a two-way data communication coupling via a network link 1021 to a local network 1022. For example, if communication interface 1020 is an integrated services digital network (ISDN) card or a modem, communication interface 1020 provides a data communication connection to the corresponding type of telephone line, which comprises part of network link 1021. If communication interface 1020 is a local area network (LAN) card, communication interface 1020 provides a data communication connection via network link 1021 to a compatible LAN. Wireless links are also possible. In any such implementation, communication interface 1020 sends and receives electrical, electromagnetic or optical signals which carry digital data streams representing various types of information.

Network link 1021 typically provides data communication through one or more networks to other data devices. For example, network link 1021 may provide a connection through local network 1022 to local server computer 1023 or to data equipment operated by ISP 1024. ISP 1024 in turn provides data communication services through the world wide packet data communication network now commonly referred to as the “Internet” 1025. Local network 1022 and Internet 1025 both use electrical, electromagnetic or optical signals which carry digital data streams. The signals through the various networks and the signals on network link 1021 and through communication interface 1020, which carry the digital data to and from computer 1000, are exemplary forms of carrier waves transporting the information.

Processor 1013 may reside wholly on client computer 1001 or wholly on server 1026 or processor 1013 may have its computational power distributed between computer 1001 and server 1026. Server 1026 symbolically is represented in FIG. 10 as one unit, but server 1026 can also be distributed between multiple “tiers”. In one embodiment, server 1026 comprises a middle and back tier where application logic executes in the middle tier and persistent data is obtained in the back tier. In the case where processor 1013 resides wholly on server 1026, the results of the computations performed by processor 1013 are transmitted to computer 1001 via Internet 1025, Internet Service Provider (ISP) 1024, local network 1022 and communication interface 1020. In this way, computer 1001 is able to display the results of the computation to a user in the form of output.

Computer 1001 includes a video memory 1014, main memory 1015 and mass storage 1012, all coupled to bi-directional system bus 1018 along with keyboard 1010, mouse 1011 and processor 1013.

As with processor 1013, in various computing environments, main memory 1015 and mass storage 1012, can reside wholly on server 1026 or computer 1001, or they may be distributed between the two. Examples of systems where processor 1013, main memory 1015, and mass storage 1012 are distributed between computer 1001 and server 1026 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Microsystems, Inc.

The mass storage 1012 may include both fixed and removable media, such as magnetic, optical or magnetic optical storage systems or any other available mass storage technology. Bus 1018 may contain, for example, thirty-two address lines for addressing video memory 1014 or main memory 1015. The system bus 1018 also includes, for example, a 32-bit data bus for transferring data between and among the components, such as processor 1013, main memory 1015, video memory 1014 and mass storage 1012. Alternatively, multiplex data/address lines may be used instead of separate data and address lines.

In one embodiment of the invention, the processor 1013 is a microprocessor such as manufactured by Intel, AMD, Sun, etc. However, any other suitable microprocessor or microcomputer may be utilized. Main memory 1015 is comprised of dynamic random access memory (DRAM). Video memory 1014 is a dual-ported video random access memory. One port of the video memory 1014 is coupled to video amplifier 1016. The video amplifier 1016 is used to drive the cathode ray tube (CRT) raster monitor 1017. Video amplifier 1016 is well known in the art and may be implemented by any suitable apparatus. This circuitry converts pixel data stored in video memory 1014 to a raster signal suitable for use by monitor 1017. Monitor 1017 is a type of monitor suitable for displaying graphic images.

Computer 1001 can send messages and receive data, including program code, through the network(s), network link 1021, and communication interface 1020. In the Internet example, remote server computer 1026 might transmit a requested code for an application program through Internet 1025, ISP 1024, local network 1022 and communication interface 1020. The received code maybe executed by processor 1013 as it is received, and/or stored in mass storage 1012, or other non-volatile storage for later execution. In this manner, computer 1000 may obtain application code in the form of a carrier wave. Alternatively, remote server computer 1026 may execute applications using processor 1013, and utilize mass storage 1012, and/or video memory 1015. The results of the execution at server 1026 are then transmitted through Internet 1025, ISP 1024, local network 1022 and communication interface 1020. In this example, computer 1001 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

What is claimed is:

1. A method for generating a performance index for a player a game comprising:
assigning a beginning performance index value to a player at the beginning of the game;
generating a change value to the performance index based on the occurrence of an event in the game;
updating the performance index value by applying the change value to the performance index.

2. The method of claim 1 wherein the beginning performance index represents a performance index of an average player in the game.

3. The method of claim 1 wherein the change value is determined by an algorithm associated with the event.

4. The method of claim 3 wherein the algorithm uses a coefficient associated with the event

5. The method of claim 4 where the coefficient is multiplied by the current performance index to result in the change value.

6. The method of claim 5 wherein the coefficient has a value based on statistics associated with the event over a time period.

7. The method of claim 6 wherein the time period is a season of games.

8. The method of claim 1 further including a plurality of events that can result in a change value.

9. The method of claim 8 wherein each position of player in a game is associated with certain of the plurality of events.

10. The method of claim 9 wherein the certain of the plurality of events is different for each position.

11. The method of claim 1 further including the step of applying an in-game decay change value to the performance index.

12. The method of claim 11 wherein the in-game decay change value is based on time elapsed during the game.

13. The method of claim 1 further including the step of applying a bench decay change value to the performance index.

14. The method of claim 12 wherein the bench decay change value is based on time elapsed during the game.

15. The method of claim 14 wherein the bench decay change value is only applied to a player who is not presently in the game.
